(19) United States
(12) Patent Application Publication
(10) Pub. No.: US 2016/0053082 A1
(43) Pub. Date: Feb. 25, 2016

(54) RUBBER PRODUCTS BASED ON IMPROVED NBR MASTERBATCH

(71) Applicants: Azemi Samsuri, Shah Alam (MY); Surina Ismail, Kuala Lumpur (MY)

(72) Inventors: Azemi Samsuri, Shah Alam (MY); Surina Ismail, Kuala Lumpur (MY)

(21) Appl. No.: 14/830,975

(22) Filed: Aug. 20, 2015

Related U.S. Application Data
(60) Provisional application No. 62/039,963, filed on Aug. 21, 2014.

(51) Int. Cl. C08K 5/101; C08C 19/00; C08K 3/04

(52) U.S. Cl. CPC C08K 5/101; C08K 3/04; C08C 19/00; C08K 2003/045

(57) ABSTRACT

Processes for dispersing nanocarbon into NBR rubber in a substantially uniform manner, nanocarbon-reinforced NBR produced by the process, and articles of manufacture produced from the nanocarbon-reinforced NBR are disclosed. The process involves preparing a nanocarbon dispersion, which optionally includes a surfactant, stabilizing agent and/or dispersant, ensuring that the nanocarbon does not include agglomerates, and mixing the dispersion with an NBR latex. The resulting composition is coagulated and dried to form an NBR-CNT (or CNT-NBR) masterbatch. After adding an appropriate additives package, the masterbatch can be formed into desired products, for example, using compression molding.

### CROSS-REFERENCE TO RELATED APPLICATION

This non-provisional application claims the benefit under 35 U.S.C. 119(e) of U.S. Provisional Patent Application No. 62/039,963, filed Aug. 21, 2014, the contents of which are hereby incorporated by reference in its entirety for all purposes.

### FIELD OF THE INVENTION

The present invention relates to methods for preparing industrial rubber products from nanocarbon-reinforced butadiene-acrylonitrile copolymers (NBR), commonly known as nitrile rubber (NBR)-NC masterbatch, where the nanocarbon can be, for example, in the form of carbon nanotubes, carbon nanofibers, and/or graphenes. Materials made from the nanocarbon-reinforced NBR are also disclosed.

### TECHNICAL BACKGROUND

Carbon nanotubes (CNTs) are allotropes of carbon with a unique atomic structure consisting of covalently bonded carbon atoms arranged in long cylinders with typical diameters in the range of 1 to 50 nm and a wide variety of lengths (Rubber Nanocomposites: Preparation, Properties and Applications; edited by Sabu Thomas and Ranimol Stephen, John Wiley & Sons, 2010). Based on the fast growing knowledge about their physical and chemical properties, nanosize carbon structures, such as carbon nanotubes or carbon nanofibers (CNT or CNF), have found a wide range of industrial applications including field effect transistors, one-dimensional quantum wires, field emitters and hydrogen storage.

Individual carbon nanotubes are characterized by a high aspect ratio (300 to 1000), high flexibility, and a unique combination of mechanical, electrical and thermal properties. The combination of these properties with their very low mass density makes them potentially useful as reinforcing fibers for high-performance polymer composites.

However, one limitation associated with using carbon nanotubes to reinforce polymer matrices is achieving a good dispersion in the composite, independent of filler shape and aspect ratio. Unless the CNT are uniformly dispersed within the polymer matrix, the mechanical strength and other relevant physical properties are not enhanced.

Direct incorporation of CNT into dry nitrile rubber through mixing processes like those used for other common fillers is not as easy as, for example, the incorporation of carbon black. Rubber is a very viscous material. It is a very difficult task to disperse a very light material, such as CNT, into a very viscous medium, such as nitrile rubber and other elastomers. Conventional mixing equipment, such as 2-roll mills, kneaders, internal mixers, and twin screw extruders, is not able to provide efficient dispersion of CNT in the rubber matrix.

Most reports and publications concerning nanoparticulate fillers for polymers relate to thermoplastics, but almost none to dry rubber. On information and belief, the main reason is that it is more difficult to mix nanoparticulate fillers into rubber than into thermoplastics, since the former is a much more viscous material than the latter, because the molecular weight of rubber is substantially higher than that of thermoplastics. The most important aspect of mixing is the final dispersion of the filler in the rubber matrix.

Carbon nanotubes as usually supplied consist largely of aggregates, but reinforcement comes from individual particles. Intercalation and exfoliation denote CNT dispersion and interaction with the polymer matrix, respectively. If intercalation and exfoliation are not attained during mixing, the final outcome is very poor mechanical strength. Thus, mixing CNTs with rubber using conventional methods does not produce the desired physical properties and mechanical strength. The root cause of the problem is associated with the poor dispersion of nanocarbon in the rubber matrix due to the high viscosity of dry rubber.

It would be advantageous to have a method for preparing nanocarbon-reinforced NBR and to improve the mechanical properties thereof. The present invention provides such a method.

### SUMMARY OF THE INVENTION

In one embodiment, the invention described herein relates to a method for dispersing nanocarbon and/or other nanomaterials into NBR rubber in such a way that the dispersion is substantially uniform.

In the methods described herein, the nanocarbon need not be subjected to an acid pre-treatment. If the nanocarbon is agglomerated, it is advantageously treated to break up any agglomerations before being mixed with the rubber, and either before or after the nanocarbon dispersion is first formed.

The nanocarbon (and/or other nanomaterials) is formed into a dispersion, which optionally but preferably includes a surfactant, and also optionally includes a stabilizing agent and/or dispersant. The concentration of nanocarbon in the dispersion is typically between about 1 and about 5 by weight (expressed as weight of the nanocarbon relative to the total weight of the dispersion).

The pH of the nanocarbon (or other nanomaterial) dispersion is typically in the range of between about 4 and about 10, more preferably between about 7 and about 9, and, ideally, around 8. Additionally, it is preferred that the pH of the nanocarbon dispersion is within about 2 pH units of the pH of the NBR latex to which it is being mixed.

The nanocarbon dispersion is then mixed with an NBR latex. The NBR latex is a dispersion of rubber microparticles in an aqueous medium. Typically, the total solids content of the NBR ranges between about 20 and about 60 percent solids, more typically between about 40 and about 50 percent solids. Typically, the pH of the NBR latex ranges from between about 4 and about 10, more typically between about 4 and about 8, more preferably between about 8 and about 9. Typically, the specific gravity (sg) of the NBR latex ranges from between about 0.9 and about 1.2, and is preferably about 1.0.

The nanotube dispersion is then mixed with an NBR latex. When mixed, the pH of the nanocarbon dispersion is ideally within about 2 units from that of the latex.

The NBR rubber composition obtained is then coagulated and dried. This final dried product is known as an NBR-CNT (or CNT-NBR) masterbatch.

The masterbatch can then be mixed with various compounding ingredients, and formed into desired products. One such product is a rubber gasket.

In one embodiment, the masterbatch is mixed with sulfur and subjected to vulcanization.

In another embodiment, the invention relates to CNT-NBR compositions with a substantially uniform distribution of nanocarbon. The substantial uniformity obtained using the mixing process described herein is a defining property of the resulting materials.

In still another embodiment, the invention relates to CNT-NBR compositions with a volume resistivity, (ohms.cm) in the range of 1×10¹³ and 50×10¹³ at an applied voltage of 7 Volts. Such conductivity is obtainable due to the substantially uniform distribution of conductive nanocarbon throughout the rubber. Such conductivity would not otherwise be possible, except perhaps with significantly higher nanocarbon loadings, i.e., greater than the 5% or higher desired level of nanocarbon in the rubber.

In still another embodiment, the invention relates to CNT-NBR compositions with one or more of the following physical properties:

Shore A Hardness in the range of between about 45 and 60;

Tensile Strength (MPa) in the range of between about 4 and 11;

Elongation at Break (EB) (%) in the range of between about 300 and 400; and

In yet a further embodiment, the invention relates to finished goods made from the CNT-NBR. Examples include rubber gaskets, such as intake manifold gaskets. Other useful products include adhesives, sealants, fuel and oil handling seals, grommets, expanded foams, rubber hoses, O-rings, rubber gloves and automotive rubber components such as fuel and oil handling seals and grommets.

The present invention will be better understood with reference to the following Detailed Description

### BRIEF DESCRIPTION OF THE DRAWINGS

FIG. 1 is a surface micrograph of a nitrile butadiene rubber (NBR) sample, including carbon nanotubes (CNT) with a diameter of about 60nm, at 100,000× magnification. The NBR matrix was produced by mixing a CNT slurry in NBR latex.

FIG. 2 is a surface micrograph of a natural NR sample (SMR10, where SMR is Standard Malaysian Rubber), at 15,000× magnification, containing 3 pphr of CNT mixed directly with SMR10.

FIG. 3 is a scanning electron microscope (SEM) micrograph of NBR masterbatch filled with 3 pphr of CNT at 25,000× magnification.

FIG. 4 is a chart showing the effect of 3 pphr of CNT on the Mooney viscosity of NBR compound. As shown in the chart, Unfilled 1=mix number 1, Unfilled 2=mix number 2, 3 ISAF=mix number 3, 3CNT NBR 2=mix number 7. Note: The Mooney viscosity of 3CNT NBR 1=mix number 6 exceeded the limit.

FIG. 5 is a chart showing the effect of 3 pphr of CNT on the hardness of vulcanized unfilled NBR compound. As shown in the chart, Unfilled 1=mix number 1, Unfilled 2=mix number 2, 3 ISAF=mix number 3, 3CNT NBR 1=mix number 6, and 3CNT NBR 2=mix number 7.

FIG. 6 is a chart showing the effect of 3 pphr of CNT on hardness of vulcanized black-filled NBR compound containing 50 pphr of ISAF black.

FIG. 7 is a chart showing the effect of 3pphr of CNT on M100 and M300 of vulcanized NBR compound. As shown in the chart, Unfilled 1=mix number 1, Unfilled 2=mix number 2, 3 ISAF =mix number 3, 3CNT NBR 1=mix number 6, and 3CNT NBR 2=mix number 7.

FIG. 8 is a chart showing the effect of 3 pphr CNT on the tensile strength of vulcanized NBR compound. As shown in the chart, Unfilled 1 =mix number 1, Unfilled 2 =mix number 2, 3 ISAF=mix number 3, 3CNT NBR 1=mix number 6, and 3CNT NBR 2=mix number 7.

FIG. 9 is a chart showing the effect of 3 pphr CNT on the tensile strength of vulcanized black-filled NBR compound containing 50 pphr of ISAF black.

FIG. 10 is a chart showing the effect of 3 pphr of CNT on the Mooney viscosity of unvulcanized black-filled NBR compound containing 50 pphr of ISAF black.

FIG. 11 is a chart showing the effect of 3 pphr of CNT on the hardness of vulcanized black-filled NBR compound containing 50 pphr of ISAF black.

### DETAILED DESCRIPTION

The present invention relates generally to the use of one or more types of nanocarbon, for instance, but not limited to, carbon nanotubes and/or carbon nanofibers, and graphenes, in the preparation of reinforced nitrile rubber (NBR).

Processes for preparing a nanocarbon-containing NBR formulation, a nanocarbon-containing NBR formulation with a substantially uniform distribution of the nanocarbon, and articles of manufacture prepared from the formulation are disclosed. As used herein, “substantially uniform” relates to a material with less than 15%, preferably less than 10% variation in the concentration of the nanocarbon throughout the material.

The processes described herein provide a relatively simple and straightforward way to overcome the problems associated with the high viscosity of dry NBR rubber, which consequently leads to agglomeration and very poor dispersion of nanocarbon in the rubber matrix. Agglomeration and poor dispersion result in poor mechanical properties, especially poor mechanical strength, which can be overcome using the processes described herein.

The resulting NBR composition, reinforced with nanocarbon, has improved physical and mechanical properties relative to reinforced NBR prepared using conventional techniques.

The reinforced NBR composition can then be subjected to other process steps, such as further mixing with the addition of other compounding ingredients such as filler(s), antidegradants, process oils, mechanical and chemical peptizers, plasticizers, accelerators and curing agents (eg sulfur, dicumyl peroxide, high etc). Mixing process can be done on a conventional 2-roll mill, internal mixer, Banbury mixer and kneader. The compounded rubber can be injection molded or compression molded to form finished articles of manufacture with improved physical and mechanical properties.

In particular, tensile strength may be used to assess the quality of the vulcanized rubber resulting from the rubber composition described herein, because it is sensitive to flaws that arise from poor filler dispersion, imperfect molding and impurities. That is, agglomerates of filler act as a flaw, and provide sites for high stress concentration where failure occurs. There is a strong correlation between poor dispersion of filler and low tensile strength. While not wishing to be bound by a particular theory, it is believed that since the nanocarbon is substantially uniformly dispersed, the resulting material has improved tensile strength.

The processes described herein provide a simple way to effectively and uniformly disperse nanocarbon in a NBR rubber matrix. Since NBR latex is in liquid form, the problem of a very viscous medium resulting from the use of dry rubber is eliminated. That is, the high viscosity of dry rubber makes it difficult to uniformly disperse nanocarbon. Consequently, the nanocarbon forms large agglomerates in the rubber matrix, which leads to poor mechanical strength.

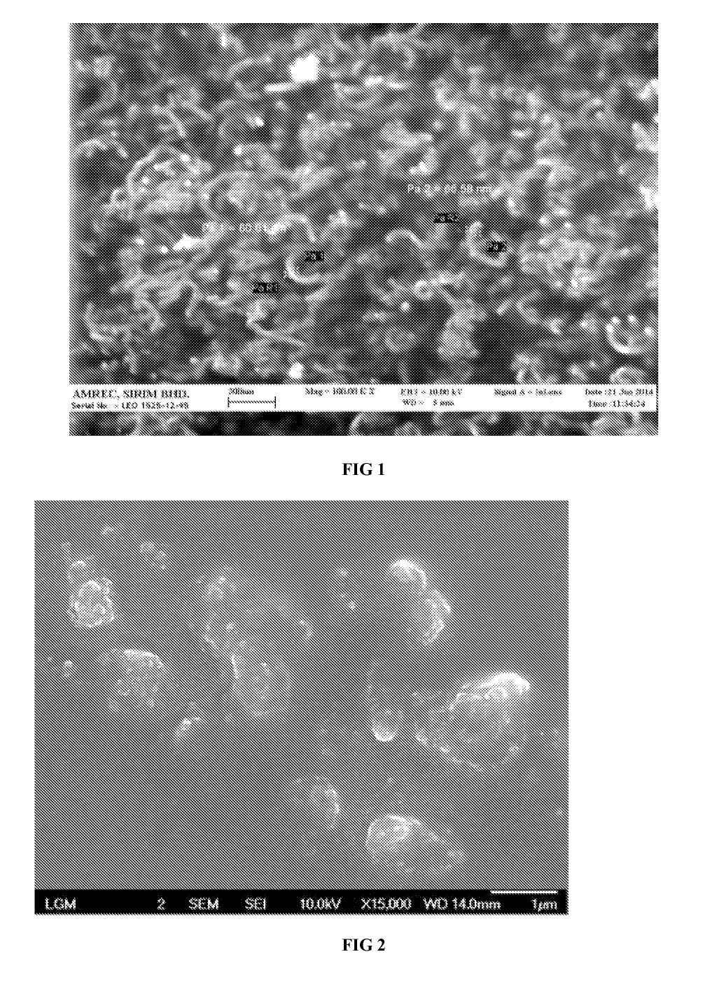

The benefits of the processes described herein can be seen in FIGS. 1 and 2. FIG. 1 is a surface micrograph of a nitrile butadiene rubber (NBR) sample, including carbon nanotubes (CNT) with a diameter of about 60 nm, at 100,000× magnification. The NBR matrix was produced by mixing a CNT slurry in NBR latex. FIG. 2 is a surface micrograph of a natural NR sample (SMR10, where SMR is Standard Malaysian Rubber), at 15,000× magnification, containing 3 pphr of CNT mixed directly with SMR10.

As seen in FIG. 2, there is a very clear evidence of undispersed CNT that exists as a big agglomerate. This agglomeration acts as a flaw and provides sites for high stress-concentration for failure to occur. This experimental evidence shows that direct mixing of CNT with dry rubber by using the conventional mixing equipment is not adequate to produce uniform dispersion in the rubber matrix.

In accordance with the present invention, it has been surprisingly discovered that adequate dispersions of CNT are achieved through mixing of CNT slurry in NBR latex, for example, as shown in FIG. 1, where large agglomerations are not observed even at 100,000× magnification. In contrast, large agglomerations are observed even at low magnification, 15,000× as shown in FIG. 2.

### Definitions

All ranges disclosed herein are to be understood to encompass any and all subranges subsumed therein. For example, a stated range of “1″ to 10″” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Additionally, any reference referred to as being “incorporated herein” is to be understood as being incorporated in its entirety.

As used herein, the term “graphene” refers to carbon atoms in the form of a very thin sheet that is only one atom thick. Since its discovery, graphene has grown central to much of the research into nanotechnology, due to the unusual electrical, magnetic, and other properties that it possesses.

The term “IRHD” as used herein refers to International Rubber Hardness Degree.

As used herein, it shall be understood that the term “nitrile rubber” (herein abbreviated as NBR), as known by those skilled in the art, also refers to, and can be used herein interchangeably with, nitrile butadiene rubber. As known to those skilled in the art, nitrile butadiene rubber is commonly understood to comprise a family of unsaturated copolymers of 2-propenenitrile and various butadiene monomers (1,2-butadiene and 1,3-butadiene). NBR is also commonly understood to those skilled in the art to comprise a synthetic rubber copolymer of acrylonitrile (ACN) and butadiene. Although it is understood that the physical and chemical properties of NBR vary depending on the polymer's composition of nitrile, it is understood that NBR is a form of synthetic rubber that is generally resistant to oil, fuel, and other chemicals. Typically, the more nitrile within the polymer, the higher the resistance to oils. Nitrile rubber is also more resistant than natural rubber to oils and acids. Nitrile rubber is also generally resistant to aliphatic hydrocarbons.

The various components used in the process, the process steps, and the articles of manufacture, are discussed in more detail below.

I. Nanomaterials Which Can Be Incorporated into the NBR

Nanocarbon and other nanomaterials can be incorporated into NBR. The term “nanocarbon” is used herein to denote nano-sized particulate forms of carbon, especially carbon nanotubes (CNTs) and/or carbon nanofibers (CNFs), graphite nanoplatelets, and graphene sheets. Carbon nanotubes are preferred.

Carbon nanotubes (CNTs) include, but are not limited to, single-wall carbon nanotubes (SWNTs), multi-wall carbon nanotubes (MWNTs), double-wall carbon nanotubes (DWNTs), buckytubes, small-diameter carbon nanotubes, fullerene tubes, tubular fullerenes, graphite fibrils, carbon nanofibers, and combinations thereof. Such carbon nanotubes can be of a variety and range of lengths, diameters, number of tube walls, chiralities (helicities), etc., and can be made by any known technique including, but not limited to, arc discharge (Ebbesen, Annu Rev. Mater. Sci. 1994, 24, 235-264), laser oven (Thess et al., Science 1996, 273, 483-487), flame synthesis (Vander Wal et al., Chem. Phys. Lett. 2001, 349, 178-184), chemical vapor deposition (U.S. Pat. No. 5,374,415), wherein a supported (Hainer et al., Chem. Phys. Lett. 1998, 296, 195-202) or an unsupported (Cheng et al., Chem. Phys. Lett. 1998, 289, 602-610; Nikolaev et al., Chem. Phys. Lett. 1999, 313, 91-97) metal catalyst may also be used, and combinations thereof.

Depending on the embodiment, the CNTs can be purified. Exemplary purification techniques include, but are not limited to, those by Chiang et al. (Chiang et al., J. Phys. Chem. B 2001, 105, 1157-1161; Chiang et al., J. Phys. Chem. B 2001, 105, 8297-8301). In some embodiments, the CNTs have been cut by a cutting process. See, e.g., Liu et al., Science 1998, 280, 1253-1256; and Gu et al., Nano Lett. 2002, 2(9), 1009-1013. The nanotubes may be functionalized using any known functionalization.

Preferred carbon nanotubes have a length of <50 μm and/or an outer diameter of <20 nm. Preferred carbon nanotubes have a C-purity of >85% and non-detectable free amorphous carbon. Such carbon nanotubes are typically supplied in the form of agglomerated bundles with average dimensions of 0.05 to 1.5 mm.

The 10,10 armchair configuration carbon nanotube has a resistivity close to copper and it is six times lighter than copper, and accordingly may be a preferred nanotube. SG-SWCNT nanotubes are extremely conductive, and can also be used.

Where graphene is used, the graphene sheets typically have 30 layers or less, such as from 1 to 30 layers.

The carbon nanotubes can be metal-coated carbon nanotubes, such as silver-coated or gold-coated nanotubes. A silver or gold coating can be applied onto carbon nanotubes, for example, by electroless plating. While not wishing to be bound by a particular theory, it is believed that the metal coating helps with the dispersion of the nanoparticles within the NBR.

The metal-coated particles can be subjected to pretreatments such as oxidation, sensitizing treatment and activation treatment, which can introduce various functional groups on the particles. These functional groups can improve the dispersion of the particles into the NBR rubber, increase the number of activated sites, and lower the deposition rate.

The carbon nanotubes, metal-coated carbon nanotubes, graphite nanoplatelets, graphene sheets, and/or nanowires can provide electrical conductivity to the resulting composite material.

The nanocarbon tube (CNT) is preferably employed without subjecting it to an acid treatment. This offers an advantage over conventional approaches to mixing nanocarbon into polymers, which typically include an acid pre-treatment of the nanocarbon. However, should any residue from the iron catalysts used to prepare the nanocarbon be present on the nanocarbon, such can be removed, for example, by treating the nanocarbon with hydrochloric acid, before the nanocarbon is mixed with the rubber.

If the nanocarbon is agglomerated or aggregated, it is advantageously treated to break down any agglomerations/aggregations before being mixed with the rubber. This treatment can occur before the nanocarbon is formed into a dispersion, or after the nanocarbon-containing dispersion is formed. However, since nanoparticles tend to re-agglomerate over time due to strong van der Waals interactions and/or electrical double layer interactions, it is preferred to use the dispersion shortly after it is formed.

### II. Nanotube Dispersion

The carbon nanotubes, or other nanomaterials, are mixed with the NBR latex while in the form of a dispersion. To form this dispersion, the nanocarbon is dispersed in an aqueous medium. As discussed in more detail below, the resulting nanocarbon dispersion is then combined with the NBR latex.

The concentration of the nanocarbon in the nanocarbon dispersion is generally between about 0.5 to 20% by weight, preferably between about 1% and about 10% by weight, more preferably between about 2 and about 55 by weight (expressed as weight of nanocarbon relative to total weight of the dispersion).

The nanocarbon dispersion is prepared by forming a slurry of the nanocarbon in an aqueous medium containing a surfactant and optionally a stabilizer.

The surfactant can be a non-ionic, cationic, anionic, or zwitterionic surfactant.

The surfactant is typically present in the slurry at a concentration of between about 0.5 and about 15% by weight, and most preferably, between about 1 and about 10% by weight of the dispersion.

Poly(acrylic acid) and fatty acid salts, such as sodium laurate, are representative anionic surfactants. Polyethylene glycol is a representative non-ionic surfactant. Hexadecyltrimethyl-ammonium bromide, tetramethylammonium hydroxide, polyethylenimine, polyvinylpyrolidone, lauryl methyl gluceth-10 hydroxypropyl dimonium chloride, and benzethonium chloride are representative cationic surfactants.

Further representative surfactants include fatty acid esters, fatty alcohol esters, alkoxylated alcohols, alkoxylated amines, fatty alcohol sulfate or phosphate esters, imidazolium and quaternary ammonium salts, ethylene oxide/propylene oxide copolymer, and ethylene oxide/butylene oxide copolymers.

Additional representative surfactants include the following surfactants: sodium lignosulfonate, sodium lauryl sulfate, sodium dodecyl sulfate (SDS), ammonium lauryl sulfate, sodium laureth sulfate, sodium lauryl ether sulfate (SLES), sodium myreth sulfate, sodium stearate, sodium lauroyl sarcosinate, perfluorononanoate, perfluorooctanoate, octenidine dihydrochloride, cetyl trimethylammonium bromide (CTAB), hexadecyl trimethyl ammonium bromide, cetyl trimethylammonium chloride (CTAC), cetylpyridinium chloride (CPC), benzalkonium chloride (BAC), benzethonium chloride (BZT), 5-bromo-5-nitro-1,3-dioxane, dimethyldioctadecylammonium chloride, dioctadecyldimethylammonium bromide (DODAB), polyoxyethylene glycol alkyl ethers (CH₃(CH₂)₁₀₋₁₆(O—C₂H₄)₁₋₂₅₀), octaethylene glycol monododecyl ether, pentaethylene glycol monododecyl ether, polyoxypropylene glycol alkyl ethers (CH₃(CH₂)₁₀₋₁₆(O—C₃H₆)₁₋₂₅₀), glucoside alkyl ethers (O-Glucoside)₁₃OH), decyl glucoside alkyl ethers, lauryl glucoside alkyl ethers, octyl glucoside alkyl ethers, polyoxyethylene glycol octylphenol ethers, polyoxyethylene glycol alkylphenol ethers, polyoxyethylene glycol nonoxynol-9 ethers, glycerol alkyl esters, glyceryl laurate esters, polyoxyethylene glycol sorbitan alkyl esters, polysorbate 20, 40, 60, 80, sorbitan alkyl esters, spans, cocamide MEA, cocamide DEA, dodecyldimethylamine oxide, block copolymers of polyethylene glycol and polypropylene glycol, poloxamers, and polyethoxylated tallow amine (POEA).

One surfactant used to prepare aqueous dispersions of nanotubes is NanoSperse AQ (NanoLab, Inc., Waltham Mass.). NanoSperse AQ is purportedly specially formulated for creating aqueous dispersions of carbon nanotubes. The recommended level is approximately four drops for every 0.1 gram of carbon nanotubes. The surfactant includes a mixture of a-(nonylphenyl)-w-hydroxy-, poly(oxy-1,2-ethanediyl), 2,4,7,9-,tetramethyl-5-decyne-4,7-diol, and 2-Butoxyethanol.

The slurry/dispersion can also include a stabilizing agent and/or dispersant. As the stabilizer, a deterioration inhibitor, for example, for preventing heat deterioration and decoloration during heating, and for improving heat-resistant aging and weather resistance can be included. Examples of the deterioration inhibitor include copper compounds such as copper acetate and copper iodide; phenolic stabilizers such as hindered phenol compounds; phosphite stabilizers; hindered amine stabilizers; triazine stabilizers; and sulfur stabilizers.

As discussed above, either before or after the dispersion is formed, the nanocarbon (or other nanomaterials) can be subjected to grinding, high-pressure jet milling, ultrasonication, and the like.

For example, the slurry thus formed can be subjected to grinding, for example, using a ball mill or an attrition mill, to break down any agglomeration or aggregation of nanocarbon. The grinding process results in a substantially uniform nanocarbon dispersion. The grinding process is typically carried out for 6 to 48 hours, preferably for 12 to 24 hours, though shorter or longer times can be used so long as the dispersion is substantially uniform. By “substantially uniform” is meant that at least about 80%, preferably at least 90%, and, most preferably, at least 95% of the nanocarbon, by weight, is not agglomerated.

The pH of the nanocarbon (or other nanomaterial) dispersion is typically in the range of between about 4 and about 10, more preferably between about 7 and about 9, and, ideally, around 8. Additionally, it is preferred that the pH of the nanocarbon dispersion is within about 2 pH units of the pH of the NBR latex to which it is being mixed. The pH of either dispersion can be adjusted as appropriate, using acids or bases, and, ideally, using buffer solutions, such as are known in the art.

### III. NBR Latex

The NBR latex is a dispersion of rubber microparticles in an aqueous medium. Typically, the total solids content of the NBR ranges between about 20 and about 60 percent solids, more typically between about 40 and about 50 percent solids. Typically, the pH of the NBR latex ranges from between about 4 and about 10, more typically between about 4 and about 8, more preferably between about 8 and about 9. Typically, the specific gravity (sg) of the NBR latex ranges from between about 0.9 and about 1.2, and is preferably about 1.0.

In addition to or in lieu of NBR, other polymers such as HNBR, isoprene, and fluorinated rubbers can be used. Representative HNBR polymers that can be use include those HNBR polymers disclosed in U.S. Publication No. 2013/0261246. Also, block copolymers, including those with polystyrene blocks and NBR blocks, can be used.

IV. Mixing the Nanotube Dispersion with the Latex Dispersion

The nanotube dispersion and latex dispersion described above are mixed to form a single dispersion which includes both the nanotubes and the latex.

As discussed above, the pH of the nanocarbon dispersion and/or of the NBR latex is/are adjusted so that the two pHs become similar or identical before the CNT dispersion and the NBR latex are combined. Preferably, the difference between the pH of the nanocarbon dispersion and the pH of the NBR latex is less than 2 pH units, more preferably less than 1 pH unit, most preferably less than 0.5 pH units before the dispersion and the latex are combined.

In one aspect of this embodiment, the resulting NBR rubber composition has a range of nanocarbon in the rubber between about 1 to about 10 pphr, preferably between about 3 and about 8 pphr, and, ideally, less than 5 pphr of nanocarbon. Even more preferably, it comprises not less than 2 pphr of nanocarbon. As used herein, “pphr” stands for parts (by weight) per hundred parts (by weight) of rubber.

The amount of nanotube in the resulting material can be determined by considering the solids concentration of the NBR latex and the solids concentration of the nanotube dispersion, and calculating a ratio of each dispersion to add to arrive at the desired weight ratio of nanotubes.

The method generally involves mixing a dispersion of nanocarbon, or other nanomaterials, with an NBR latex. This mixing can be accomplished using any known mixers, including vortex mixers, static mixers, and the like.

The nanocarbon dispersion and the NBR latex may be combined by adding the nanocarbon dispersion (and optionally a surfactant) to the NBR latex, for example by discharging the former into a vessel containing the latter. In one embodiment, the order of addition is reversed, such that the NBR latex is added to the nanocarbon dispersion.

The mixture thus obtained is generally subjected to mechanical stirring until a uniform mixture is obtained.

### V. Coagulation of the Nanocarbon-Containing Latex

The mixture containing the NBR latex and the nanocarbon can then be coagulated. This coagulation “sets” the distribution of the nanocarbon within the rubber.

The coagulation can be accomplished using known methods, for example by adding calcium chloride (typically at around a 20% concentration), calcium nitrate (typically at around a 15 to 25% concentration) and/or sulfuric acid (typically at a 40 to 70% concentration).

The coagulum thus formed may be washed with water and squeezed to remove excess surfactants, coagulants, water, and other water-soluble components of the mixtures.

The coagulum can then be cut into small granules, typically in the size of between about 5 and about 10 mm, and washed with water. These granules can then be dried, for example in an electrically heated oven, until they are fully dried, such as to a moisture content of less than about 1% by weight. Alternatively, the coagulum can be passed into a creeper to remove the water inside the coagulum, and sheeted out to a thickness typically in the range of about 5 mm before drying, for example, in an electrical oven, to complete dryness.

The resulting dry product can be used in the granulated form, or can be pressed into a bale (block rubber) form. The dry product may be used as CNT-NBR master batch for a wide variety of NBR rubber applications, in the same manner as dry NBR grades.

The resultant CNT-NBR masterbatch preferably has a viscosity (Mooney viscosity, M_{L} (1+4) 100° C.) of around 50 to 80 Mooney units. Occasionally, the masterbatch has a very high viscosity (Mooney viscosity, M_{L} (1+4) 100° C. is the range of 90 to 120 Mooney units). In such cases, it can be desirable to reduce the viscosity by adding one or more of a chemical plasticizer, a dispersing agent, a homogenizing agent, and a mechanical peptizer.

Representative plasticizers include aliphatic alcohols, aliphatic amides, aliphatic bisamides, bisurea compounds, polyethylene waxes, p-(octyloxy)benzoic acid and N-butylbenzene sulfonamides. Specific plasticizers include dioctyl phathalate (DOP) and dioctyl sebacate (DOS).

Representative dispersing agents include saturated fatty acid esters (such as Struktol WB16 or WB222). Struktol 40MS is a representative homogenizing agent (Struktol Company of America, Stow, Ohio). The homogenizing agent is typically used to improve the homogeneity of elastomers of different polarity and viscosity, and is rapidly absorbed by the polymers during the mixing cycle. A relatively low viscosity mass can thus be quickly achieved, into which other compounding ingredients can easily be incorporated.

Struktol A5OP and A60 (Struktol Company of America, Stow, Ohio), zinc soaps of unsaturated fatty acids, are examples of mechanical peptizers. These peptizers provide a faster physical peptization of rubbers, and can start to be effective in the lower temperature range of compounding and can be used for mastication in a separate stage as well as for single stage mixing.

These chemicals may be incorporated into the NBR latex during mixing with the nanocarbon dispersion, or alternatively by mixing directly into the CNT-NBR masterbatch on a 2-roll mill or in an internal mixer. Thus, the composition and method of the present invention overcome the problem of poor dispersion of nanocarbon when direct mixing of nanocarbon with dry rubber and yield improved physical properties and mechanical strength of the rubber composition.

### VI. Addition of Further Components

Additional components can be mixed with the CNT-NBR masterbatch. Examples of suitable additives include carbon black, antioxidants, and curing agents.

In one aspect, the components and additives are as follows: 100 phr (parts per hundred) CNT-NBR; approximately 40 phr total carbon black or other suitable amount depending on the desired mechanical properties to be achieved. The carbon black can be from a single source/grade or multiple grades. The components can also include about 5 phr or less antioxidants (e.g., one or a variety of oxidation inhibitors) and approximately 5 phr or less curing agent or other suitable amounts depending on physical properties to be achieved. Useful curing agents include peroxides and sulfur based curing agents.

Additives can also include plasticizers, barrier molecules (e.g., to prevent fluid swell or fluid penetration), viscosity modifiers, lubricity modifiers, and simple volume fillers.

In those embodiments where the CNT-NBR is to be subjected to vulcanization, such vulcanization is typically conducted using elemental sufur. Alternative crosslinking agents apart from elemental sulfur can also be used.

### VII. Vulcanization or Other Crosslinking

Crosslinking can be carried out using sulfur vulcanization or other covalent crosslinking approaches.

A variety of methods exist for vulcanization. The economically most important methods use high pressure and temperature after the curing agents have been added to the rubber.

A typical vulcanization temperature is around 170° C., with a cure time of around 10 minutes. Advantageously, vulcanization or other cross-linking occurs while the mixture is present in a mold, a technique known as compression molding. The resulting rubber article adopts the shape of the mold.

Other methods include hot air vulcanization and microwave heated vulcanization, both of which are continuous processes.

The following list of representative curing systems can be used:

Metallic oxides

Peroxides

Sulfur systems

Of these, sulfur systems and peroxides are discussed in more detail below.

Where sulfur vulcanization is used a vulcanization accelerator is typically also used, along with other additives such as activators like zinc oxide and stearic acid, and antidegradants. Retarding agents that inhibit vulcanization until some optimal time or temperature can also be used. Antidegradants can be used to prevent degradation of the vulcanized product by heat, oxygen and ozone.

Where an organic peroxide is used as a source of free radicals to effect free radical crosslinking of double bonds present in the NBR, any organic peroxide used for peroxide crosslinking can be used, without limitation. Specific examples include benzoylperoxide, dicumylperoxide, 2,5-dimethyl-2,5-di-(t-butylperoxide)hexane, 1,1′-di-(t-butylperoxi)-diisopropylbenzene, n-butyl-4,4-di-(t-butylperoxi)valerate and 1,1-di-(t-butylperoxi)cyclohexane, etc., among which use of dicumylperoxide or 1,1′-di-(t-butylperoxi)-diisopropylbenzene is preferred.

The organic peroxide can be added in an amount of around 0.5 to 10 parts by weight, or more preferably by 0.8 to 5 parts by weight, relative to 100 parts by weight of rubber. Adding organic peroxide by less than 0.5 parts by weight does not achieve sufficient vulcanization of rubber, while adding it by more than 10 parts by weight causes the rubber to scorch and prevents complete flow of the rubber thus prevents complete shaping process.

### VIII. Formation of Elastomeric Rubber Parts

In one embodiment, the CNT-NBR described herein is used to prepare gaskets. In other embodiments, the elastomeric composite can be used to form part of a ship, boat, hull, damping panel, seal, stretchable device, bumper, vibration mount, shock absorber, bellow, expansion joint, catheter, bearing pad, stopper, glove, balloon, tubing, conduit, pipe, casing, adhesive, footwear, grommet, bushing, bearing, clothing, fastener, connector, washer, inner tube, diaphragm, roofing material, hose, valve ball, valve seat, hydraulic cup, o-ring, roller, wheel, and spark plug cap.

These articles of manufacture can be prepared, for example, using compression molding techniques. This typically involves placing un-vulcanized rubber in a mold, and vulcanizing the rubber using heat and pressure, such that it maintains the shape of the mold.

The present invention will be better understood with reference to the following non-limiting examples.

### EXAMPLES

The nanocarbon used in the examples was carbon nanotubes having a length of <50 μm and an outer diameter of <20 nm, a C-purity of >85% and non-detectable free amorphous carbon. It was employed as supplied, i.e. without pretreatment. In that state, it existed as agglomerated bundles of CNTs with average dimensions of 0.05 to 1.5 mm.

All percentages stated in the examples are by weight unless stated otherwise. As is common in the field of rubber technology, “pphr” stands for parts per hundred parts of rubber.

### Example 1

### 1. Preparation of Nanocarbon Slurry and Nanocarbon Dispersion

A 3% nanocarbon dispersion was prepared from 15 g of nanocarbon, 75 g of surfactant and 410 g of distilled water as shown in Table 1.

TABLE 1
Preparation of 3% CNT dispersion

| Ingredients | pphr | Total weight (g) |
|---|---|---|
| CNT (C-100) | 3 | 15 |
| 20% Surfactant | 15 | 75 |
| Distilled Water | 82 | 410 |
| Total | | 500 |

The mixture was stirred by means of mechanical stirrer at 80 rpm for about 10 minutes to obtain a nanocarbon slurry. The slurry was transferred to a ball mill for grinding to break down any nanocarbon agglomerates. Ball milling was done for 24 hours, though can be extended for up to 72 hours or more necessary, to obtain a nanocarbon dispersion, which was then transferred into a plastic container.

The pH of the CNT dispersion was adjusted to that of the NBR latex to which it was to be added. In this case, the pH of CNT dispersion was adjusted to between 8 and 10 by adding potassium hydroxide (KOH).

### 2. Preparation of Nanocarbon-Containing NBR Rubber Master Batches

The nanocarbon dispersion prepared as described above was mixed with NBR latex. The NBR latex was used at 45% concentration without further dilution, though it is possible to dilute the latex to around 30% if thickening occurs during mixing. The mixing with the nanocarbon dispersion was then done in the presence of about 5 pphr of surfactant (employed as a 5% to 20% solution) as shown in Table 2.

TABLE 2
Preparation of 3 pphr CNT-NBR masterbatch
from 3% CNT (C-100) dispersion

| | | Wet | Total wet |
|---|---|---|---|
| Ingredients | pphr | weight (g) | weight (g) |
| 3% C-100 | 3 | 100 | 300 |
| 10% Potassium laurate | 5 | 50 | 150 |
| 45% NBR latex | 100 | 222.2 | 666.6 |
| total | | 372.2 | 1116.6 |

The nanocarbon dispersion and the surfactant were discharged into a suitable container containing the NBR latex. The mixture was subjected to mechanical stirring for 60 minutes at stirring speed of 80-100 rpm at 23-30° C.

The NBR latex filled with CNT was then coagulated with one of the following coagulants—sulfuric acid (40-70% concentration), calcium nitrate (15-25% w/w concentration) and calcium chloride (15-20% w/w concentration). The coagulum formed was washed with water and squeezed to remove excess surfactants and water. The coagulum was further soaked in water overnight. The next day, the coagulum was cut into small granules and washed with water. These granules were then dried in an electrically heated oven at 50-80° C. until they were fully dried, to obtain a nanocarbon-containing NBR rubber masterbatch.

### 3. Preparation of CNT-NBR Rubber Gasket Compound and Evaluation of Physical Properties of Vulcanizate

Rubber compounds were prepared by mixing the CNT-NBR masterbatch with sulfur, accelerator, zinc oxide and stearic acid by using either a 2-roll mill or in a laboratory internal mixer. The full formulations are shown in Table 3.

The cure characteristic of the compounded rubber was determined by means of curemeter at 150° C. Various test-pieces were prepared by compression molding, and vulcanized to its optimum state of cure at 150° C.

TABLE 3
Compound formulation for Rubber Gasket

| | | Specifi- | Specifi- |
|---|---|---|---|
| | pphr | cations 1 | cations 2 |
| Ingredients | | | |
| Nitrile Rubber (NBR - High | 80 | | |
| ACN content) | | | |
| CNT NBR masterbatch | 23 | | |
| Zinc oxide | 5 | | |
| Nonox BL or (Permanex B) | 1 | | |
| Stearic acid | 1 | | |
| GPF Black | 25 | | |
| FEF Black | 25 | | |
| China clay | 10 | | |
| Shellflex 250MB | 5 | | |
| DOP | 10 | | |
| Cumarone indene resin | 2 | | |
| Insoluble sulfur | 1.8 | | |
| MBTS | 1.5 | | |
| Vulcafor MS (TMT) | 0.4 | | |
| Physical properties | | | |
| Hardness, Shore A | 70 | 70-80 | 67 |
| Tensile strength (MPa) | 13.5 | 9.96 | 11.9 |
| EB (%) | 250 | 250 | 210 |
| Compression set (%), 22 hrs | 34 | 50 (max) | 43 |
| at 100° C. | | | |
| Vulcanizate properties after heat | | | 70 hrs at |
| aging at 100° C. for 70 hrs | | | 177° C. |
| % change in TS | +7 | ±30 (max) | −15 |
| % change in EB | −22 | −50 (max) | −25 |
| Hardness, Duro A, pts | +5 | ±15 points | +10 |

Specifications 1: Nitrile Rubber (NBR) Gasket Material, Requirements of ASTM D 2000 MBK 7 10Z. Ref: Romac Industries Inc, Romac Document No 45-8-0005.
Specifications 2: Transmission gasket or O-ring, British Standards Institution BSI 3158: 1977 (The aging conditions - aged in air 70 hrs at 177° C.)

### 4. Discussion of Results

### 4.1 Unaged Properties

### 4.1.1 Hardness

The formulation above meets both the hardness specified by ASTM D2000 MBK and also that of BSI 3158:1977.

### 4.1.2 Tensile Strength

The CNT-filled NBR compound gave the highest tensile strength compared to the two specifications, indicating the reinforcing effect of the CNT.

### 4.1.3 Elongation at Break

The compound formulation meets both specifications.

### 4.1.4 Compression Set

The compound formulation produced the best result, giving the lowest compression set among the two specifications.

### 4.2 Aged Properties

### 4.2.1 Hardness

The compound formulation based on CNT-NBR masterbatch gave very good aging resistance, where the increase in hardness after aging was +5 points much away from the limits ±15 points.

4.2.2. Tensile strength

The CNT-filled NBR compound formulation also gave excellent retention of the tensile strength after heat aging where the tensile strength increased by +7 points far away from the maximum permissible value of ±30 (max).

### 4.2.3 Elongation at Break

The CNT-filled NBR compound formulation also gave reasonably good retention of the elongation at break, EB, after heat aging where the EB decreased by −22 points far away from the maximum permissible value of −50 (max).

### 5.0 Conclusion

The CNT-filled NBR compound was found to meet the specifications for NBR rubber gasket specified by ASTM D 2000 MBK 7 10Z. (Ref: Romac Industries Inc, Romac Document No 45-8-0005).

### Example 2

### Preparation of Nanocarbon-Containing NBR Rubber Master Batches

A CNT nanocarbon dispersion was mixed with NBR latex (Nipol LX550L). The NBR latex was used at 45% concentration without further dilution. Dilution to 30% is necessary if thickening occurs during mixing. The mixing with the nanocarbon dispersion was then done in the presence of about five (5) pphr of surfactant (employed as a 5% to 20% solution) as shown in Table 5.

TABLE 5
Preparation of 3 pphr CNT-NBR masterbatch
from 3% CNT (C-100) dispersion

| | | Wet | Total wet |
|---|---|---|---|
| Ingredients | pphr | weight (g) | weight (g) |
| 3% C-100 | 3 | 100 | 300 |
| 10% k. laurate | 5 | 50 | 150 |
| 45% NBR latex | 100 | 222.2 | 666.6 |
| Total | | 372.2 | 1116.6 |

The nanocarbon dispersion and the surfactant were discharged into a suitable container containing the NBR latex. The mixture was subjected to mechanical stirring for 60 minutes at stirring speed of 80-100 rpm at 23-30° C.

The NBR latex filled with CNT was then coagulated with one of the following coagulants such as sulfuric acid (40-70% concentration), calcium nitrate (15-25% w/w concentration) and calcium chloride (15-20% w/w concentration). The coagulum formed was washed with water and squeezed to remove excess surfactants and water. The coagulum was further soaked in water overnight. The next day, the coagulum was cut into small granules and washed with water. These granules were then dried in an electrically heated oven at 50-80° C. until they were fully dried to obtain a nanocarbon-containing NBR rubber masterbatch.

### Preparation of Rubber Compound and Evaluation of Physical Properties of CNT-NBR Vulcanizate

Rubber compounds were prepared by mixing the CNT-NBR masterbatch with sulfur, accelerator, zinc oxide and stearic acid by using either a 2-roll mill or in a laboratory internal mixer. The full formulations are shown in Table 5. The cure characteristic of the compounded rubber was determined by means of curemeter at 150° C. Various test-pieces were prepared by compression molding, and vulcanized to its optimum state of cure at 150° C.

TABLE 5
Mix formulations

| Mix number | 1 | 2 | 3 | 4 | 5 | 6 | 7 | 8 | 9 |
|---|---|---|---|---|---|---|---|---|---|
| NBR (Krynac 3345F) | 100 | 100 | 100 | 100 | 100 | — | — | — | — |
| CNT -NBR MB | — | — | — | — | — | 103 | 103 | 103 | 103 |
| ISAF (N220) | — | — | 3 | 50 | 50 | — | — | 50 | 50 |
| ZnO | 3 | 3 | 3 | 3 | 3 | 3 | 3 | 3 | 3 |
| St. Acid | 2 | 2 | 2 | 2 | 2 | 2 | 2 | 2 | 2 |
| Santoflex 13 (6PPD) | 1 | 1 | 1 | 1 | 1 | 1 | 1 | 1 | 1 |
| DOP | — | 5 | 5 | — | 5 | — | 8 | — | 8 |
| Process oil (Nytex 840) | — | — | — | 4 | — | — | — | 4 | — |
| Sulphur | 1.5 | 1.5 | 1.5 | 1.5 | 1.5 | 1.5 | 1.5 | 1.5 | 1.5 |
| TBBS | 1.4 | 1.4 | 1.4 | 1.4 | 1.4 | 1.4 | 1.4 | 1.4 | 1.4 |

The hardness (in terms of the International Rubber Hardness Degree (IRHD)), the 100% and 300% modulus (strictly speaking, stress at 100% and 300% strain; M100 and M300) and the tensile strength was then determined by standard methods.

Tensile strength can be measured using any suitable approach. In this example, tensile strength was measured by using a tensile machine in accordance with ISO 37.

### CNT Dispersions by Field Emission Scanning Electron Microscope (FESEM)

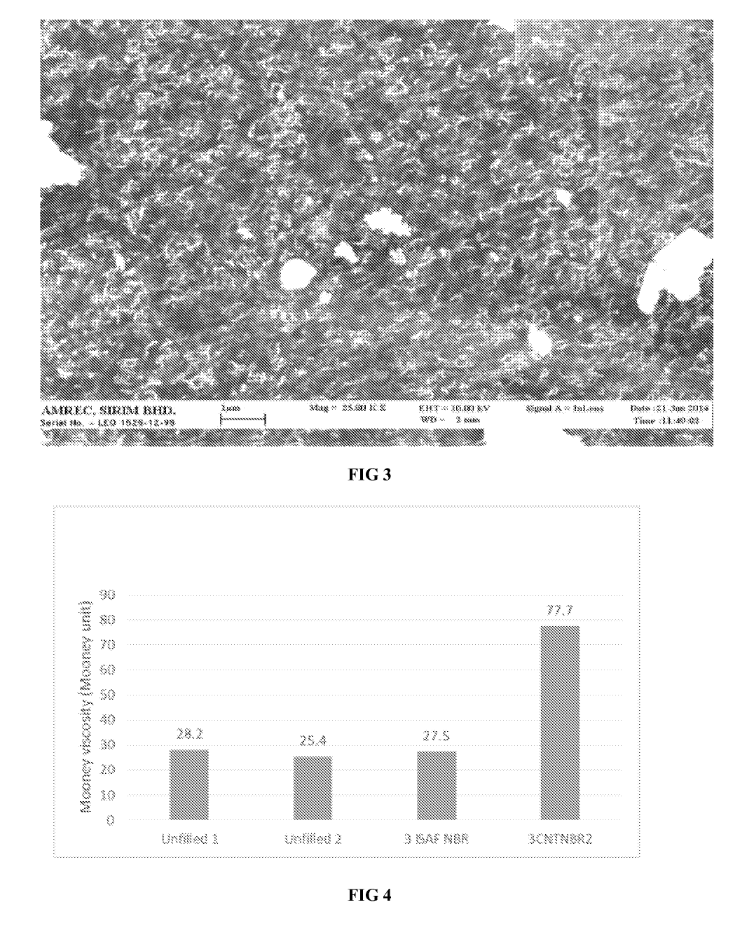

Sample was placed in the container filled with liquid nitrogen for 10 minutes. Then the hard and freeze sample was crushed and one piece of the cross section surface of the sample was placed on the SEM sample stub attached with carbon tape. The sample was then sputter coated with gold particle, and was insert into the SEM chamber for measurement. The sample micrograph was captured using Field Emission Scanning Electron Microscope (FESEM) model LEO 1525. The result is shown in FIG. 3 where the CNT is dispersed adequately within the NBR rubber matrix as shown in the micrograph at 25,000 magnification.

### Electrical Resistivity

The electrical resistivity test was also conducted as a means of assessing the CNT dispersion in the rubber matrix. The electrical resistivity test was done in accord with the BS 903: Pt. C1: 1991 & Pt. C2 : 1982. The results are shown in Table 6.

TABLE 6
Results of Electrical Resistivity

| Test Parameters | Unfilled NBR | CNT-Filled NBR |
|---|---|---|
| Applied voltage, (V) | 35 | 7 |
| Surface resistivity (ohms) | 9.59 × 10^{l0} | 8.04 × 10⁹ |
| Volume resistivity, | 1.69 × 10¹⁰ | 6.31 × 10⁸ |
| (ohms · cm) | | |

It is well established that rubber is an excellent electrical insulator. Unfilled NBR has very high electrical resistivity as indicated by the high surface resistivity as well as its high volume resistivity. In contrast CNT filled NBR has lower electrical resistivity than unfilled NBR. The presence of CNT in the NBR matrix provided electrical path. These are completely surprising and unexpected results of the present invention. The surface conductivity of CNT filled NBR is about 10× more conductive than unfilled NBR, and the bulk of CNT filled NBR is about 60× more conductive than unfilled NBR. The enhancement in the electrical conductivity is attributed to CNT filler dispersed within the NBR matrix. Both the SEM micrograph and electrical resistivity tests complement each other implying that good dispersion of CNT in the NBR matrix has been achieved.

### Physical Properties

The results of the representative physical tests conducted on both unvulcanized and vulcanized rubber compounds are shown in Table 7.

TABLE 7
Rheological properties of unvulcanized rubber compound
and physical properties of vulcanized rubber

| | | | | | | | | | |
|---|---|---|---|---|---|---|---|---|---|
| Mix number | 1 | 2 | 3 | 4 | 5 | 6 | 7 | 8 | 9 |

A) Properties of unvulcanized rubber compound

| | | | | | | | | | |
|---|---|---|---|---|---|---|---|---|---|
| V_{c} (M_{L} 1 + 4 @100° C.) | 28.2 | 25.4 | 27.5 | 57.5 | 33.2 | VL | 77.7 | VL | 90 |

B) Rheometer at 150° C.

| | | | | | | | | | |
|---|---|---|---|---|---|---|---|---|---|
| t2 (minutes) | 4.6 | 3 | 3 | 3 | 3 | 2.4 | 4.9 | 2 | 0.5 |
| t95 (minutes) | 17.5 | 17 | 17 | 18.5 | 16.5 | 24 | 17 | 25 | 15 |

C) Physical properties of vulcanized rubber

| | | | | | | | | | |
|---|---|---|---|---|---|---|---|---|---|
| Hardness (IRHD) | 44 | 40 | 41 | 66 | 66 | 69 | 52 | 89 | 81 |
| M100 (MPa) | 0.9 | 0.8 | 0.9 | 2.4 | 2.45 | 3.45 | 2.13 | — | 9.39 |
| M300 (MPa) | 1.44 | 1.2 | 1.4 | 11.4 | 11.14 | — | 6.75 | — | — |
| Tensile strength (MPa) | 2.8 | 2.6 | 3.1 | 24 | 23.6 | 4.6 | 11.1 | 13.3 | 21.4 |
| EB (%) | 497 | 590 | 520 | 510 | 529 | 150 | 387 | 75 | 205 |

VL—exceeds viscosity limit (222.4 Mooney units)

### Mooney Viscosity of Unvulcanized Rubber Compounds

Mooney viscosity is a common rheological test to determine the resistance to flow and the resistance to deformation of unvulcanized rubber compounds. Low viscosity rubber compound facilitates flow and reduce heat generation during shaping process, but has poor collapse resistance after the shaping process. High viscosity rubber compound is preferred to low viscosity rubber compound during extrusion of complicated profiles and hollow tubing since the former has higher collapse resistance than the latter. High viscosity rubber compound gives lower extrudate swell than low viscosity rubber compound, thus the former would provide higher extrusion output because bigger die can be used than the latter. FIG. 4 shows the effect of incorporation of 3 pphr of CNT into unfilled NBR compounds. Mixes 1 and 2 are unfilled NBR compounds that produced very low Mooney viscosity. The addition of 3 pphr of reinforcing ISAF black hardly increases the Mooney viscosity. However, the addition of 3 pphr of CNT into NBR (mix 6) has increased the Mooney viscosity substantially to its viscosity limit 222.4 Mooney units, that make it detrimental to mixing process. This substantial increase in viscosity of the rubber compound might be associated with the very strong interaction between the CNT and the rubber chains. For this reason, platicizer such as dioctyl phathalate (DOP) was incorporated during mixing of the CNT-NBR masterbatch. The addition of 8 pphr of DOP decreased the Mooney viscosity CNT-NBR compound to an acceptable level of 78 Mooney unit. The incorporation of 50pphr of ISAF black into NBR has increased the Mooney viscosity by 104% relative to unfilled NBR compound.

### Hardness

The hardness of unfilled vulcanized NBR is in the right region of 40-45 IRHD as shown in FIG. 5. In the case of CNT-NBR masterbatch, the hardness is 69 IRHD (mix 6). The enhancement in the hardness by 3 pphr of CNT is more than the reinforcement exhibited by the addition of 50pphr of ISAF black. The addition of 8 pphr of DOP has decreased the hardness to 52 IRHD because of the plasticizing effect associated with DOP.

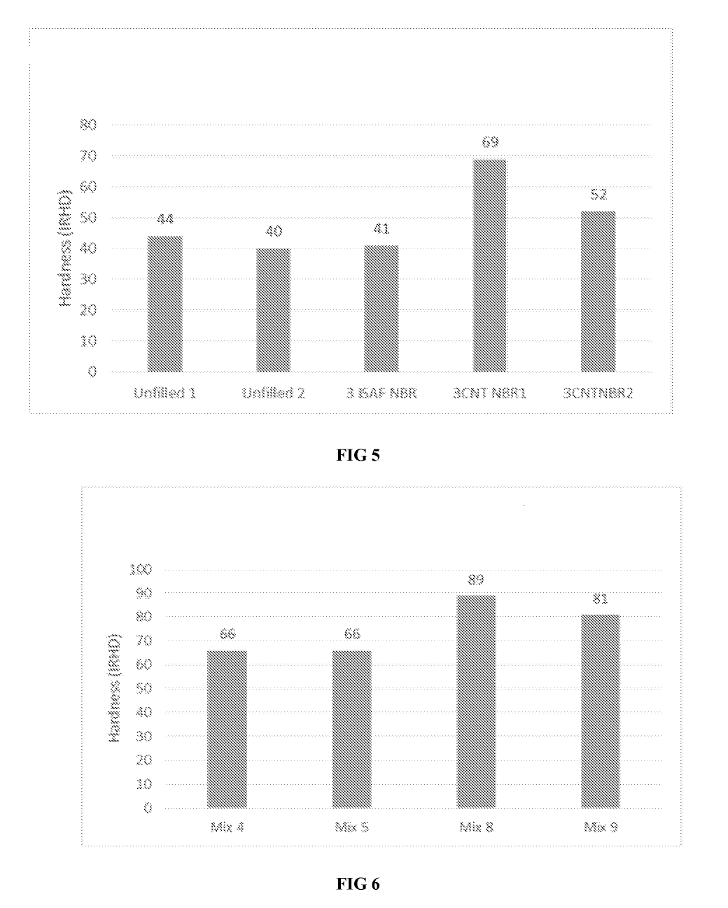

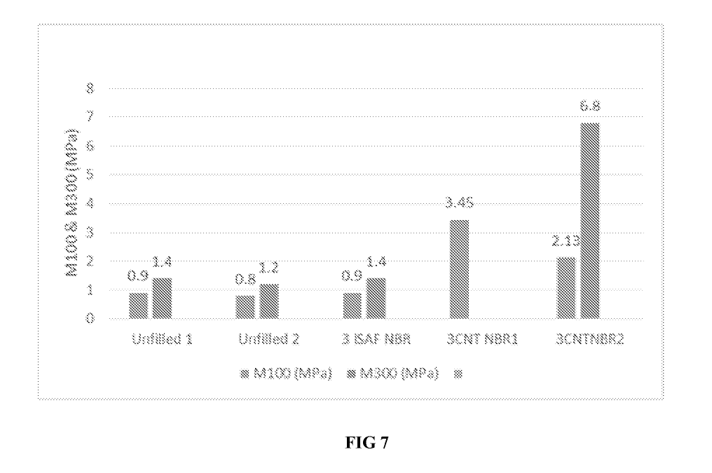

The addition of 50 pphr of ISAF black has increased the hardness to 66 IRHD as shown in FIG. 6. With the addition of 50 pphr of ISAF, the hardness of CNT-NBR vulcanized rubber (mix 8) has increased to 35% compared with mixes 4 and 5. The substantial increase in hardness can be exploited for the design of rice husk roller disc where the typical hardness required is in the range of 90 to 110 IRHD. The enhancement in the hardness is a clear evidence of the reinforcing effect exhibited by CNT.

### Tensile Stress at 100% (M100) and 300% Strain (M300)

The effect of incorporation of 3 pphr of CNT tensile stress at 100% strain (M100) and tensile stress at 300% strain (M300) is shown in FIG. 7. The trend is almost the same as that of hardness. Both M100 and M300 of 3 pphr CNT filled NBR are much higher than that of unfilled NBR and that filled with 3 pphr of ISAF black. The increase in M100 and M300 of CNT filled NBR provide clear evidence of the enhancement of the reinforcing effect of CNT. The M100 for CNT-NBR vulcanized rubber is even higher than 5Opphr ISAF black-filled NBR indicating high reinforcement in the stiffness of the rubber imparted by the CNT.

### Tensile Strength and Elongation at Break

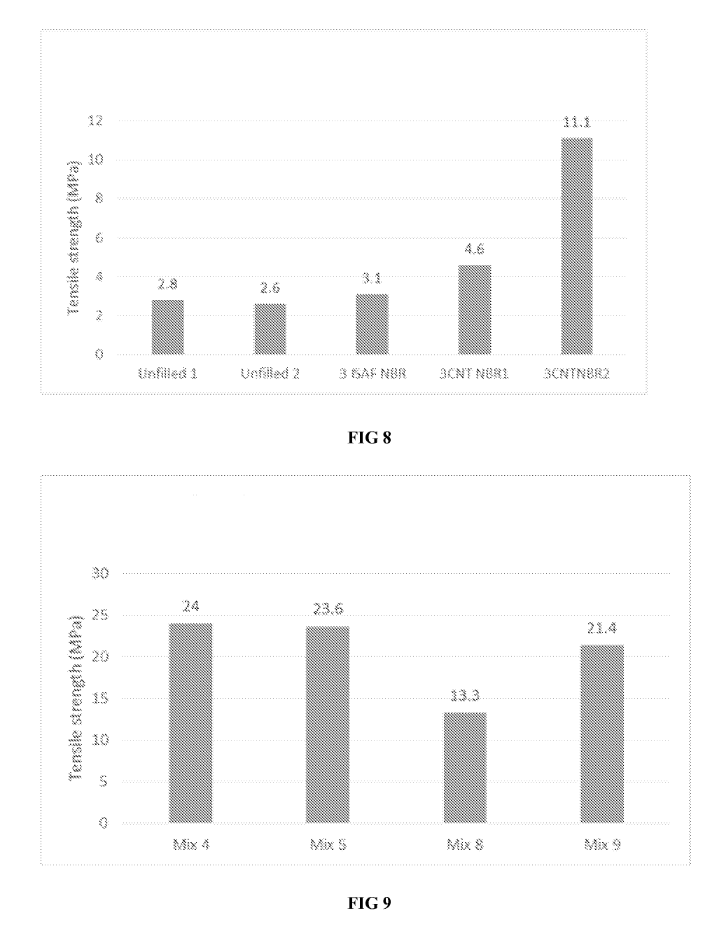

The tensile strength of unfilled NBR is relatively low 2.6-2.8 MPa as shown in FIG. 8. The addition of 3 pphr of CNT (mix 6) has increased its tensile strength to 4.6 MPa (increase by 77%). However, with the addition of 8 pphr of DOP, the tensile strength has increased to 11.1MPa (increase by 4.3 times compared to unfilled NBR, mix 2). This shows clear evidence that 3 pphr of CNT provides sufficient reinforcement to enhance the mechanical strength of NBR. However, the addition of 50 pphr of ISAF black into CNT-NBR masterbatch does not appear to increase further the tensile strength as shown in FIG. 9 probably because the substantial increase in the hardness and stiffness causes the vulcanizate to fail at low strain as reflected by the low elongation at break.

### Effect of CNT on Black-Filled NBR

The results of the effect of CNT on black-filled NBR are shown in Table 8.

TABLE 8
Rheological properties of unvulcanized black-filled NBR rubber
compound and physical properties of vulcanized rubber

| | | | | |
|---|---|---|---|---|
| Mix number | 4 | 5 | 8 | 9 |

Properties of unvulcanized rubber compounds

| | | | | |
|---|---|---|---|---|
| V_{c} (M_{L} 1 + 4 @100° C.) | 57.5 | 33.2 | VL | 90 |

Cure characteristics at 150° C.

| | | | | |
|---|---|---|---|---|
| t2 (minutes) | 3 | 3 | 2 | 0.5 |
| t95 (minutes) | 18.5 | 16.5 | 25 | 15 |

Properties of vulcanized rubber

| | | | | |
|---|---|---|---|---|
| Hardness (IRHD) | 66 | 66 | 89 | 81 |
| M100 (MPa) | 2.4 | 2.45 | — | 9.39 |
| M300 (MPa) | 11.4 | 11.14 | — | — |
| Tensile strength (MPa) | 24 | 23.6 | 13.3 | 21.4 |
| EB (%) | 510 | 529 | 75 | 205 |

### Effect of CNT on Mooney Viscosity of Black-Filled NBR

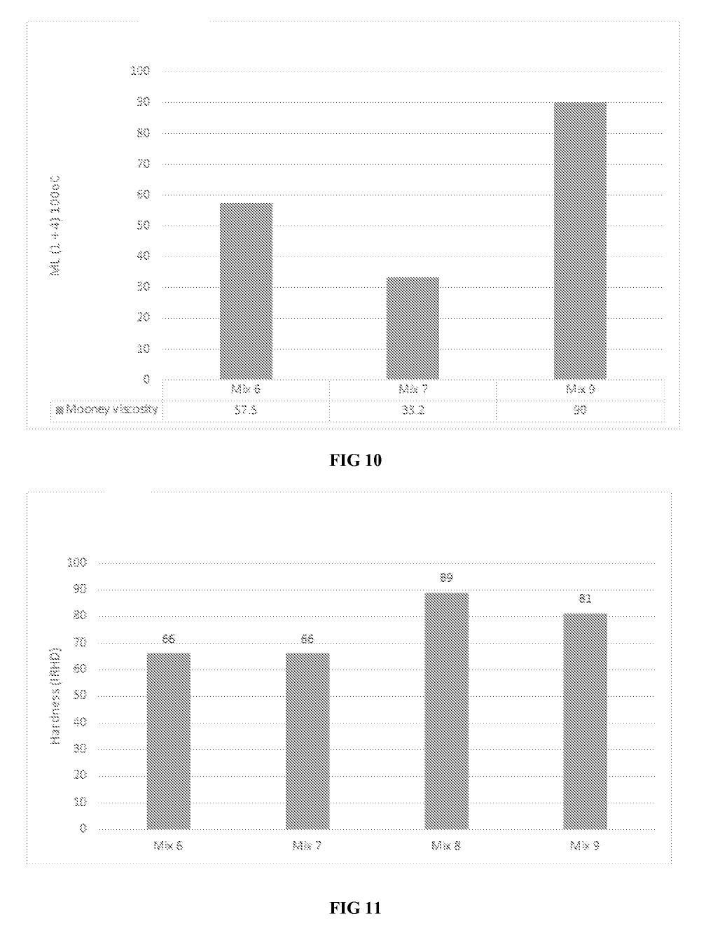

The incorporation of 50 pphr of ISAF black into NBR increased the Mooney viscosity by 104% relative to unfilled NBR compound (mix 1). The incorporation of CNT into black-filled NBR increased the viscosity of the rubber compound substantially. The incorporation of DOP helps to reduce the viscosity. The results are shown in FIG. 10.

### Effect CNT on Hardness

The addition of 50 pphr of ISAF black increased the hardness to 66 IRHD relative to unfilled vulcanizate as shown in FIG. 11. With the addition of 50 pphr of ISAF, the hardness of CNT-NBR vulcanized rubber (mix 8) increased to 35% compared with mixes 4 and 5. The substantial increase in hardness can be exploited, for example, for the design of rice husk roller disc where the typical hardness required is in the range of 90 to 110 IRHD.

As described herein, and as shown by certain representative embodiments and examples described herein, the present invention has been observed to possess numerous surprising and unexpected beneficial properties, including but not limited to the following:
1. It has been surprisingly and unexpectedly observed that CNT, for example 3 pphr of CNT, provides enhancement of hardness and tensile strength of vulcanized CNT-NBR masterbatch relative to vulcanized unfilled NBR and black-filled NBR. It is to be understood that this is just a representative embodiment, and that the present invention contemplates other amounts of CNT (e.g. in pphr) that also provides enhancement of hardness and tensile strength.
2. It has also been surprisingly and unexpectedly observed that it is beneficial to incorporate mechanical peptizer and chemical plasticizer to reduce the viscosity of the CNT NBR masterbatch to facilitate mixing and dispersion of CNT and other compounding ingredients in the rubber.
3. According to certain embodiments of the invention, it is desired to adjust the amount of carbon black and plasticizer accordingly to get a suitable level hardness level, for example, 65-70 IRHD.
4. It has also been surprisingly and unexpectedly observed that without treating the CNT with acid solution, the physical properties of vulcanized rubber filled with untreated (virgin) CNT are better than acid treated CNT.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

1. A process for preparing a nanocarbon-reinforced nitrile rubber (NBR) composition, comprising the steps of:
a) forming an aqueous dispersion of a non-agglomerated nanocarbon, wherein the dispersion optionally includes one or more additional agents selected from the group consisting of surfactants, stabilizing agents, and dispersants, b) obtaining an aqueous NBR latex formulation, and c) adding the nanocarbon dispersion to the NBR latex formulation or adding the NBR latex formulation to the nanocarbon dispersion, with mixing.

2. The process of claim 1, further comprising coagulating the NBR latex formulation, and drying the coagulate, to form a nanocarbon-reinforced NBR composition.

3. The process of claim 2, further comprising adding an additive package suitable for vulcanizing the NBR to the nanocarbon-reinforced NBR composition.

4. The process of claim 3, further comprising vulcanizing the NBR.

5. The process of claim 1, wherein the pH of each of the aqueous NBR latex formulation and nanocarbon dispersion is in the range of between about 4 and about 10 before they are mixed, and wherein the pH of the NBR latex formulation is within 2 pH units of the pH of the nanocarbon dispersion when mixed.

6. The process of claim 1, wherein the nanocarbon is not subjected to an acid treatment before it is used in the process.

7. The process of claim 1, wherein the nanocarbon is in the form of carbon nanotubes (CNTs), carbon nanofibers (CNFs), graphite nanoplatelets, or graphene sheets.

8. The process of claim 1, wherein the total solids content of the NBR latex formulation ranges between about 20 and about 60 percent solids, the pH of the NBR latex ranges from between about 4 and about 10, and the specific gravity (sg) of the NBR latex ranges from between about 0.9 and about 1.2.

9. The process of claim 1, wherein upon mixing, the concentration of nanocarbon in the NBR is between about 0.5 and about 20 pphr.

10. The process of claim 1, wherein the nanocarbon is substantially uniformly dispersed throughout the NBR, wherein substantially uniformly dispersed means that the dispersity varies by no more than fifteen percent throughout the NBR.

11. A nanocarbon-reinforced NBR formulation prepared according to the method of claim 1.

12. An article of manufacture comprising the nanocarbon-reinforced NBR formulation of claim 11.

13. The process of claim 9, wherein the composition comprises between about 2 and about 5 pphr of nanocarbon.

14. The process of claim 1, wherein the step of providing the dispersion of nanocarbon comprises the steps of forming a slurry of the nanocarbon in an aqueous medium containing a surfactant and subjecting the slurry to grinding.

15. The process of claim 14, wherein the grinding is ball milling.

16. The process of claim 1, further comprising the step of coagulating the mixture, and drying the coagulant, to form a CNT-filled NBR masterbatch.

17. The process of claim 16, wherein the CNT-filled NBR masterbatch is pre-masticated by incorporating with a mechanical peptizer and/or a chemical plasticizer into the dispersion.

18. The process of claim 1, further comprising forming the nitrile rubber composition comprising nanocarbon into a gasket using compression molding techniques.

19. A vulcanized nanocarbon-reinforced NBR formulation, comprising between about 0.5 and about 20 pphr nanocarbon by weight of the formulation, wherein the nanocarbon is substantially uniformly dispersed in the formulation.

20. The formulation of claim 19, wherein the formulation has a volume resistivity in the range of 1×10¹³ and 50×10¹³ ohm.cm at an applied voltage of 7 volts.

21. The formulation of claim 19, wherein the formulation has a Shore A Hardness in the range of between about 45 and 60.

22. The formulation of claim 19, wherein the formulation has a tensile strength (MPa) in the range of between about 4 and 11.

23. The formulation of claim 19, wherein the formulation has an elongation at break (%) in the range of between about 300 and 400.
